(19) United States
(12) Patent Application Publication
(10) Pub. No.: US 2011/0253699 A1
(43) Pub. Date: Oct. 20, 2011

(54) PORTABLE FOOD WARMER WITH CARBON FIBER HEATING ELEMENT

(76) Inventors: Philip K. Morin, Bristol, CT (US); Stanley G. Tomalesky, Planisville, CT (US); Herbert Kleinegger, Bristol, CT (US)

(21) Appl. No.: 12/878,083

(22) Filed: Sep. 9, 2010

Related U.S. Application Data
(63) Continuation-in-part of application No. 12/761,614, filed on Apr. 16, 2010.

(51) Int. Cl. H05B 1/00

(52) U.S. Cl. 219/387; 219/482

(57) ABSTRACT

This invention generally relates to a portable food warmer including a cavity having an insulated chafing pan installed therein, said pan including one or more walls or panels embedding a plurality of carbon fiber tow heating elements, the heating elements electrically connecting to a controllable power source utilizing a connector having an upper and lower portion that engagingly fastens a portion of said tow between ribbed protrusions and ribbed troughs to hold said fiber in position, such that the power source enables the heating of food.

### CROSS-REFERENCE TO RELATED APPLICATIONS

This is a continuation-in-part of and claims the priority benefit under 35 U.S.C. 120 of U.S. patent application Ser. No. 12/761,614 entitled A High Temperature Connector and Method for Manufacturing, filed Apr. 16, 2010, the entire disclosure of which is hereby incorporated by reference herein.

### FIELD OF INVENTION

The present invention relates generally to a portable food warmer sufficient to cook and to keep food warm, utilizing a carbon fiber tow heater with a novel power connector.

### BACKGROUND

Portable food warmers for both cooking and serving are found in the prior art. Other uses for such apparatuses are for catering services such as tailgate events, camping and as strategic or emergency food supply in disasters or military operations.

Food catering services typically serve prepared foods from a buffet style line using chafing pans, dishes or trays, which usually include a stand for holding and for positioning a heat source under a double-boiler pan. The double-boiler pan may be partially filled with water with the chafing pan nested into its cavity. The prior art, (e.g., U.S. Pat. No. 5,517,903), discloses chafing pans dependent upon heat supplied by candles or heat chemicals. These type chemicals are inefficient, cumbersome, dangerous and environmentally undesirable. In some instances the transportation of prepared hot food products require interim heating methods and devices from the point of cooking to the point of delivery. This is especially the case when chemicals, often made from denatured and jellied alcohol, are burned directly from their containers to heat foods at the delivery point.

The heating devices in other instances are pre-heated ceramic discs or external electrical coil heaters that heat water, over which the chafing pan is installed, but these typically have problems in uniform heat distribution. However, the requirement for water presents yet another requirement that is inefficient and unwieldy, especially when the chafing pan is being transported.

Carbon tow heaters may solve the problems that pre-heated ceramic discs or external electrical coil heaters that heat water, however an important requirement in using such heaters is the reliability of the electrical connector. U.S. Pat. No. 7,662,002 discloses an assembly for connecting a tow of axially elongated carbon fibers with a plurality of discrete contact portions, referred to as a tow into a metal “u” shaped trough with knurled ridges. manufacturing this type of connector requires pressing down a top male die with ridges to squeeze the carbon fiber layers and then uses ultrasonic welding to fix the fibers to contact points. a pneumatically activated carriage mechanism applies pressure to the preassembled parts. the '002 processes uses a 1000 watt ultrasonic welder producing a 20 khz frequency and a long weld time of 600 milliseconds at 60 joules of energy. The heating elements of the prior art such as the '002 patent have several problems that limit their usability. The first problem arises because the ultrasonic energy causes the carbon fibers to vibrate and some portion of them migrate beyond the sides of the polyester film causing shorts to ground when voltage is applied. The method of manufacture utilizing ultrasonic welding also slows down the manufacturing of the assembly. Additionally ultrasonic welding of carbon fibers to metal is unreliable when the connector temperature exceeds a temperature of 400 F. What is required is a novel connector to allow the safe and reliable use of carbon tow heaters in chafing pans by the general public.

A product that incorporates a method and apparatus for safe, reliable cooking and for maintaining food at the proper temperatures, and that eliminates the requirement for water as a heat transfer means, used in both transportation and at locations for serving, is desirable.

### SUMMARY OF THE INVENTION

The present invention relies in part on the recognition of the aforementioned problems and provides an apparatus and method directed to the safe, reliable cooking and maintenance of food at the proper temperatures used in both transportation and at locations for serving.

The present invention relates to a portable food apparatus that includes a cavity having a generally metallic pan installed therein, said pan having a enclosing surfaces, wherein one or more carbon fiber tow heating elements are affixed to one or more of said surfaces, said pan including the heating elements installed into an insulation material, said heating elements electrically connecting to a controllable power source utilizing a connector having a metallic upper and lower portion that engagingly fastens a portion of said tow between ribbed protrusions and ribbed troughs to hold said fiber in position, such that the power source enables the heating of food.

The invention includes a connector for holding the fibers in position and for attaching a power source to heat the fibers. The connector engagingly fastens a portion of the tow between ribbed protrusions and ribbed troughs using an upper and lower portion to grip the fibers in its jaw.

The portable food utility includes a controller that measures the temperature in the pan and maintains a preset temperature to cook or keep food warm.

The invention is also embodied in a method for controlling the temperature of the portable food utensil includes attaching a carbon fiber tow heater onto the inner wall of the pan; connecting a power source to the heater utilizing a connector having an upper and a lower mating portion substantially opposing each other; heating the wall transferring heat to the surface and the space in contact with the food; receiving data from a manually set input device representing a desired temperature for the internal space or for the food in the pan; receiving data from a first sensor representing the temperature of one of the internal space or the food; receiving data from a second sensor representing the temperature of the carbon fiber tow heater; controlling the supply of power to the heater dependent on the first sensor data, the second sensor data, and the data representing a desired temperature to cook or keep food warm.

In another embodiment the invention is computer software for controlling the temperature of the novel portable food apparatus as described above, as embodied on a computer readable medium that includes code for: receiving data from a manually set input device representing a desired temperature for the internal space or for the food in the pan; receiving data from a first sensor representing the temperature of one of the internal space or the food; receiving data from a second sensor representing the temperature of the carbon fiber tow heater; controlling the supply of power to the heater dependent on the first sensor data, the second sensor data, and the data representing a desired temperature to cook or keep food warm.

### BRIEF DESCRIPTION OF THE DRAWINGS

Understanding of the present invention will be facilitated by consideration of the following detailed description of the preferred embodiments of the present invention taken in conjunction with the accompanying drawings, in which like numerals refer to like parts, and wherein:

FIG. 1a is a perspective view of a portable food apparatus according to an embodiment of the present invention;

FIG. 1b is a perspective view of a portable food apparatus according to an embodiment of the present invention;

FIG. 2 is a perspective cut away view of a portable food apparatus according to an embodiment of the present invention;

FIG. 3a is a is a perspective view of a chafing pan showing the carbon fiber tow layout according to an embodiment of the present invention;

FIG. 3b is a is a cross-sectional view of a chafing pan wall where the heater is embedded, according to an embodiment of the present invention;

FIG. 4a illustrates a top view of a heater assembly for a portable food chafing pan in accordance with an embodiment of the present invention;

FIG. 4b illustrates an end view of a heater assembly for a portable food chafing pan in accordance with an embodiment of the present invention;

FIG. 5a illustrates a perspective view of a connector for a portable food chafing pan in accordance with an embodiment of the present invention;

FIG. 5b illustrates a perspective view of a connector for a portable food chafing pan in accordance with an embodiment of the present invention;

FIG. 6a illustrates a plan view of the heater assembly for a portable food chafing pan in accordance with an embodiment of the present invention;

FIG. 6b illustrates an electrical schematic of two heater assemblies connected in series for a portable food chafing pan in accordance with an embodiment of the present invention;

FIG. 6c illustrates an electrical schematic of two heater assemblies connected in parallel for a portable food apparatus heater in accordance with an embodiment of the present invention;

FIG. 7 illustrates a system diagram for a controller, heater, sensor and power source for a regulating the heat in a portable food apparatus in accordance with an embodiment of the present invention.

### DESCRIPTION OF THE INVENTION

It is to be understood that the figures and descriptions of the present invention have been simplified to illustrate elements that are relevant for a clear understanding, while eliminating, for the purpose of clarity, many other elements found in food utensils and methods of using the same. Those of ordinary skill in the art may recognize that other elements and/or steps may be desirable in implementing the present invention. However, because such elements and steps are well known in the art, and because they do not facilitate a better understanding of the present invention, a discussion of such elements and steps is not provided herein.

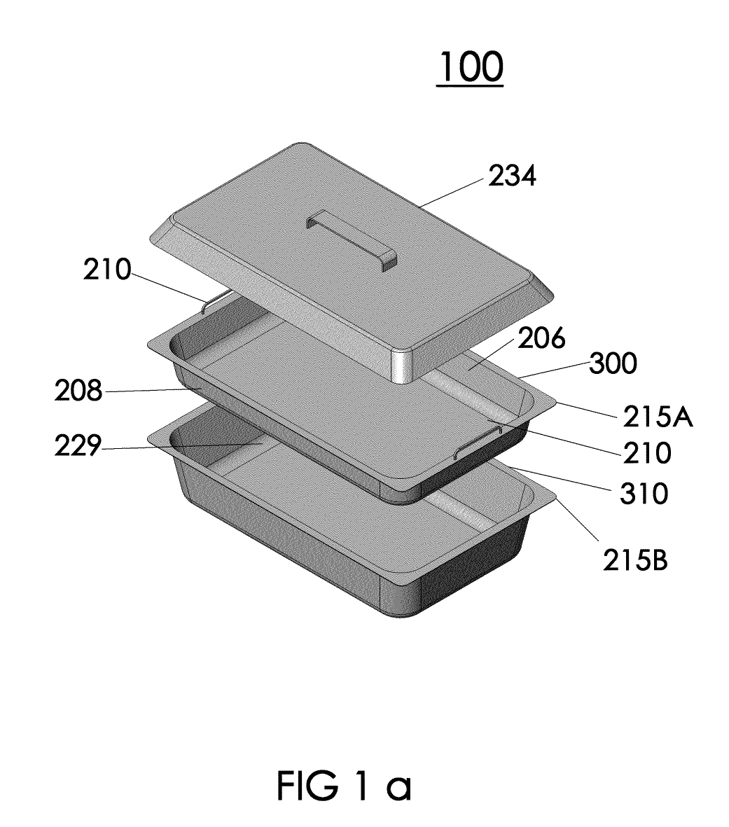

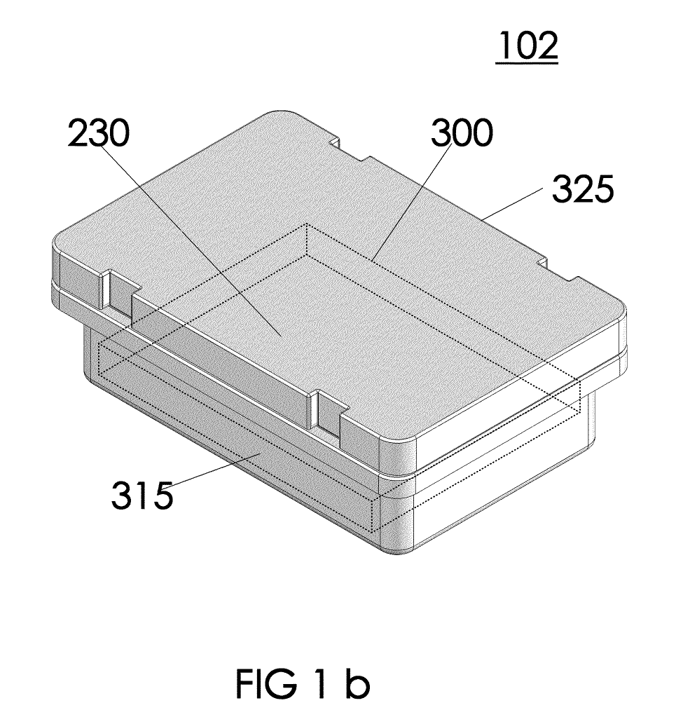

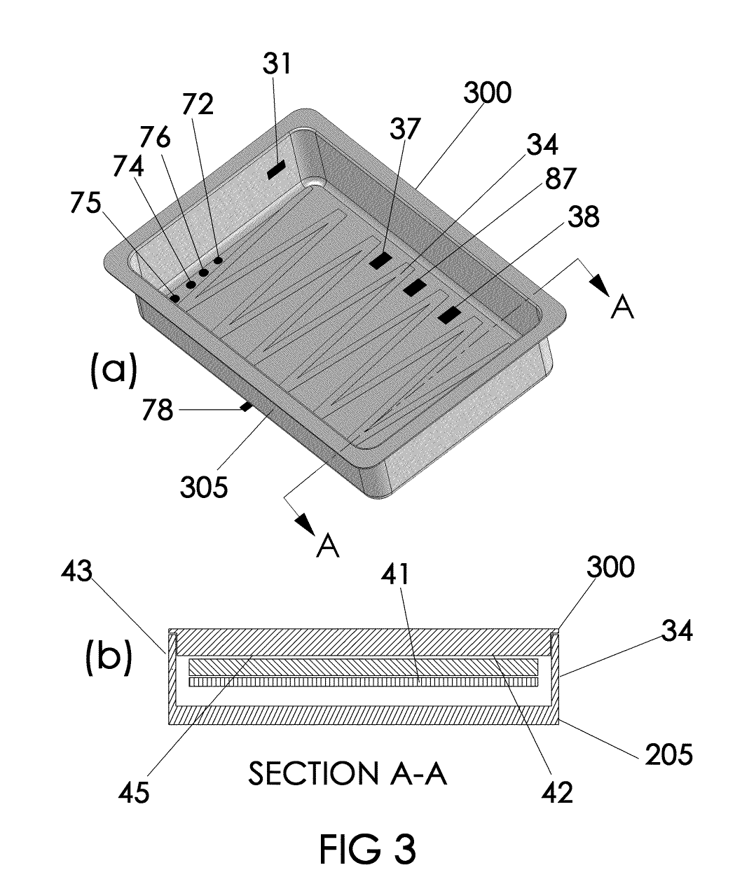

One embodiment of the present invention includes a portable food utensil 100 as shown in FIG. 1a. The utensil 100 includes a top 234 cover, typically constructed from metal, such as stainless steel, a pan 300, typically with four sides and a bottom (See, FIG. 3a) constructed from metal, such as stainless steel and a lower cavity 229 into which the pan fits. The pan 300 contains handles 210 mounted opposite sides 206, 208 which assist in placing the pan 300 into the cavity 229.

In an alternate embodiment, a portable food utensil 102 is shown in FIG. 1b and includes an insulated cavity 230. The insulated cavity 230 is formed from a lower half 315 and a removable upper half 325 which generally serves as a cover. The broken lines show the pan 300 (See, FIG. 3a) as hidden and nested in the insulated cavity 230, between the lower half 315 and the upper half 325.

As will be described below, one or more walls and/or lower surface of the pan 300 have affixed thereon a plurality of electrically powered carbon fiber tow heating 34 elements (FIG. 3a). The electrically powered elements make it unnecessary to utilize the prior art candles or external chemical heaters, sometimes in combination with heated water in the lower cavity, to keep the pan 300 sufficiently heated to cook or keep food warm. As will be further described below, the pan 300 is also insulated so as to retain the heat provided via the electrical heater.

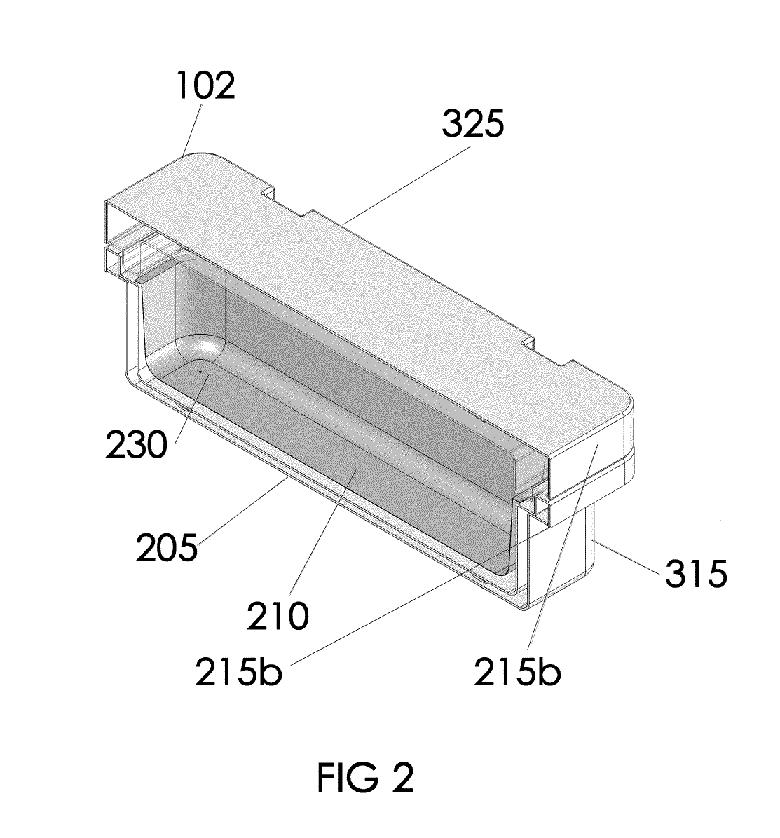

FIG. 2 illustrates a cut away of the embodiment of the portable apparatus 102 shown in FIG. 1b, wherein insulation material 205 forms the cavity 230, within which the pan 300 (FIG. 3a) is contained. The cavity retains internal heat, without the requirement to place it into a bath of water, due to the thermal resistance provided by the insulating material 205 of the lower portion 315 of the portable apparatus 102.

In certain uses, the containers shown in FIG. 1a and FIG. 1b, allow at a given time, for more than one pan 300 to be installed in the well or cavity 229, 230 respectively. The top covers 234, 325 of the respective embodiments, shown as apparatuses 100, or 102, seals the containment of pan 300 in any optional way forming a tight seal via lip 215a, 315b, that is effective through a full 360 degrees of the apparatuses 100 or 102.

FIG. 3a illustrates the container or pan 300 for cooking or keeping foods warm, without the need for candles, coil heaters or heated water. The outside surface 305 is generally a metallic material, although the invention also contemplates that ceramics, plastics or other engineered materials may be employed. In one embodiment pan 300 may be constructed from a unitary outer structure formed of stainless steel or aluminum. In one embodiment of the invention the heater 34 may be affixed to any one or combination thereof of the walls of pan 300.

By way of further illustration in FIG. 3a, the lower surface 45 of bottom panel 42 is in direct contact with the heater 34. This method of directly affixing the carbon fiber tow 30a heater 34 to bottom panel 42 is in contrast to other forms of electrical heaters that may require insulation between a wire heating element and the pan to prevent electrical conduction, between the heating element and the bottom of a metallic pan. Additionally the carbon tow is generally flat and provides a heat distribution over a larger area per unit length of the heater than wire heating elements. Direct contact and the wider heat distribution make the carbon fiber heating apparatus more efficient than competing wire heating apparatuses.

As shown in FIG. 3b section A-A, the bottom panel 42, is in direct contact with a carbon fiber tow heater 34. The opposite or lower surface of the carbon fiber tow heater 34 is in contact with a bonding material 41 to keep the former fastened to the bottom panel 42. The bonding material 41 is also in contact with an insulation material 205, as in one embodiment (FIG. 102), the pan 300 rests in the insulated cavity 230. In the embodiment shown in FIG. 1a, the insulation material 205 is ceramic wool that wraps the chafing pan 300 in a blanket encapsulating the chafing pan 300 along its sides and bottom and therefore insulating the heater 34.

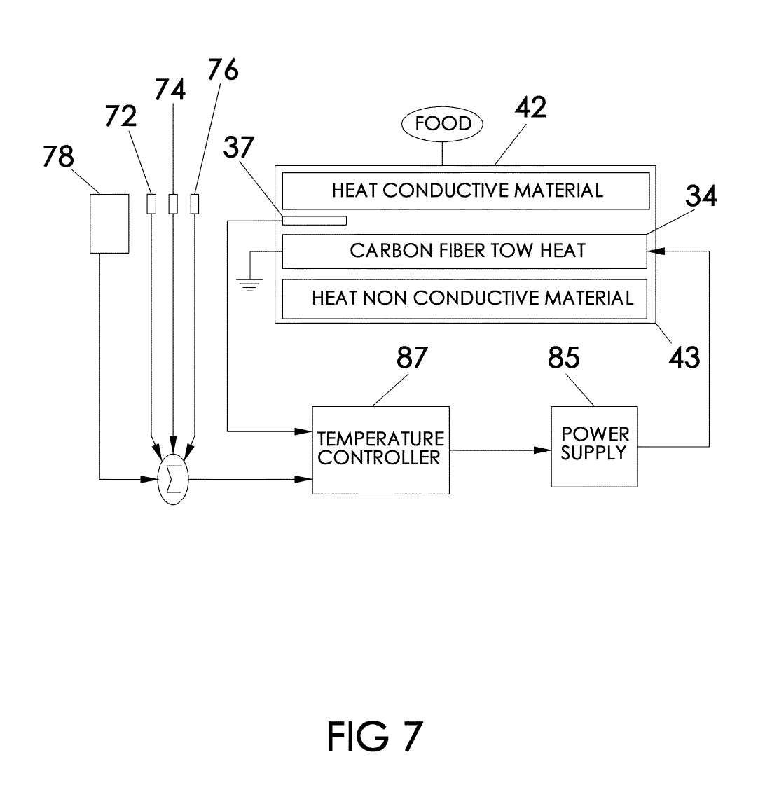

The heater 34 control elements (FIG. 7) are also optionally situated within one of the chafing pan walls, installed for example, between the lower part 43 and the upper part 42 of the wall. However, as is apparent, any of the other walls of the pan 300 may be suitable for mounting the control elements.

Referring again to FIG. 3a, the elements related to temperature control include a heater controller 87, a manually adjustable temperature setting device, such as, by way of example and not limitation potentiometer 78, and temperature sensors, by way of example and not limitation, a sensor 72 for measuring the temperature in the space of the span, a sensor 76 for measuring the temperature on the internal surface of the pans and a connection for a sensor 74 that can be inserted into the food itself to measure the temperature of the food. In other embodiments a control element acts as a heat limiter to keep heat at some prescribed minimum such as below 200 F. degrees to keep food from drying up. For example, in such an embodiment, a further feature incorporates a heat limiter 38 that shuts down or reduces power to the heater when the temperature reaches at 170 F. degrees and re-powers when the food temperature falls below 155 F. In yet another embodiment a sensor 37 measures the temperature of the connector that attaches to the carbon fiber tow to the power source.

In one embodiment a power source 85 is also connected to the chafing pan 300 through a suitable connector 31. However, it is anticipated that in certain applications of the utensil 100, 102, the power source 85 may itself be mounted into the wall of the chafing pan 300.

After installation of the heater 34, controller 87 and heater control elements, and ancillary connections such as connector 74, and power source 85 connector 31, the lower part 43 and the upper part 42 seal in any suitable manner known to those of ordinary skill in mechanical fabrication of metallic and compositional materials.

The pan 300 controller 87 computes conditions related to the desired temperature in the internal space or well of the pan 300, which may include the external and internal pan temperature or the temperature of the food. These temperatures in turn are used to control the electrical power to the heater 34 in turn regulating the temperature in the well of the pan 300. The regulation of the temperature in the well of the pan or the food may require taking into account heat loss through the walls of the pan 300 and the insulation 205 material of the apparatus 100, using by way of example and not limitation, one or more of (a) the material density of the insulation 205, (b) specific coefficient of heat of the insulation 205, or (c) the thermal conductivity of the of the insulation 205 in a computation for regulating the temperature in the pan 300 or the temperature of the food. The controller 87 also may utilize data for at least one of the cross-sections of the insulation 205 for maximizing the efficiency of the heat generated by the tow fiber heater 34. The controller 87 in addition may utilize data for the volume of the insulation 205 between the heater and the surface of the insulation for maximizing the efficiency of the heat generated by the tow fiber heater 34. The electrical circuit will be more fully described with reference to FIG. 7.

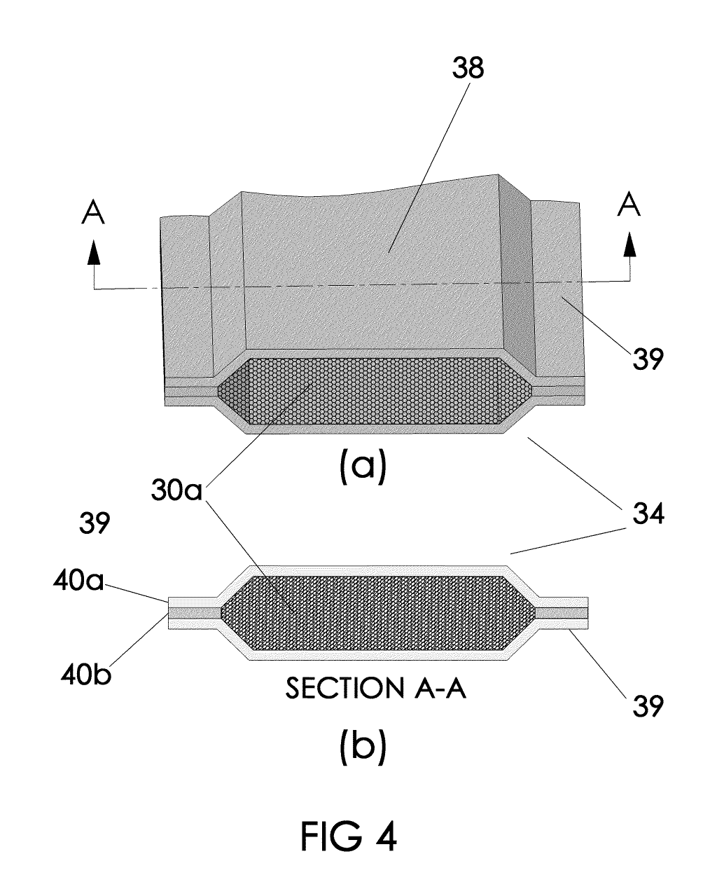

Referring to FIG. 4a and FIG. 4b, the invention the heater 34 is comprised of an electrically insulated carbon fiber tow 30a that is utilized as the main component of the heater 34. The tow provides an extended surface that contains from about 1,000 to about 100,000 generally cylindrical carbon filaments or fiber strands each having a diameter ranging from 6 to 10 microns and an electrical resistant at ambient temperature 75 F. degrees in the range of 2 to 3 ohms per linear foot, plus or minus 0.10 ohm. The flexible carbon strands, which comprise the tow 30a are of indeterminate length and are disposed in generally side-by-side parallel relation to each other. Prior to termination, the carbon fiber tow 30a are disposed within a single bundle having a substantially flat, generally oval or elliptical cross section throughout its entire length.

In the embodiment shown in FIG. 4a a self-fusing silicone tape contains that the carbon fiber tow upper surface in a sheath and the sheath is bonded to the lower surface 45 of the pan 300. The silicone tape requires no adhesive to form a sheath because it chemically bonds to itself upon contact at ends 39. Once the bonding is complete the heater 34 is capable of operating in a temperature range of −65 F to 700 F. In the alternate embodiment as discussed with respect to FIG. 3b, the carbon fiber tow heater 34 is bonded directly to the lower surface 45 by only a lower layer of the self-fusing silicone tape or other bonding material, such that the bonding material 41 is in direct contact with the carbon fiber tow heater 34.

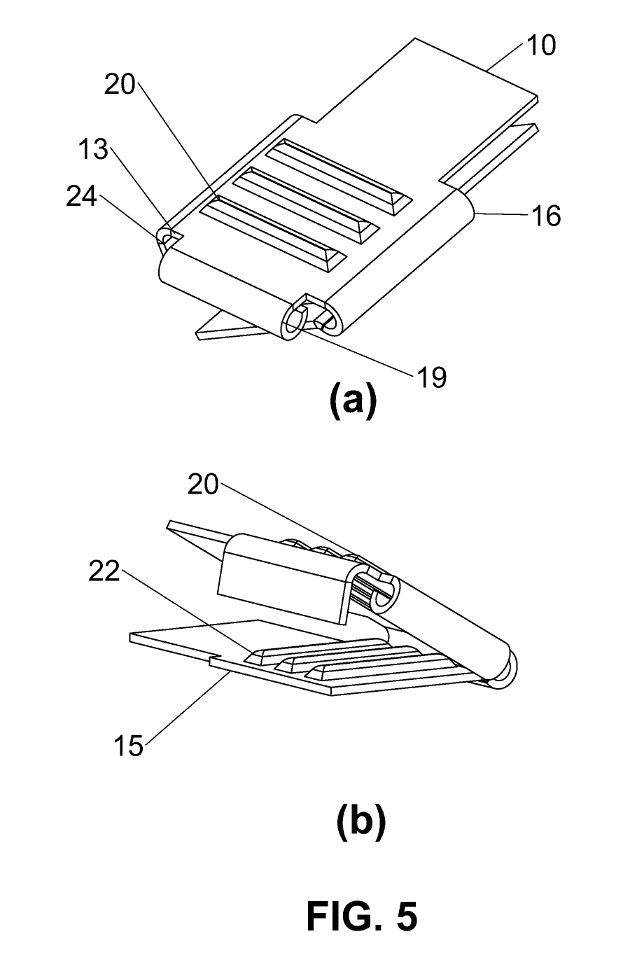

As shown in FIG. 5a, one embodiment of the invention utilizes connector 10 for attaching an electrical power source to a conductive fiber tow 30a embedded in the wall of the portable food apparatus (See, FIG. 3a). With reference to FIG. 5a, FIG. 5b one embodiment of the invention includes heating element 34 utilizing the carbon fiber tow 30a terminated in the connector 10. Connector 10 includes a sheet 15 formed around bend 19 into opposing upper and a lower portions wherein said upper portion includes a plurality of parallel ribbed troughs 20 and said lower portion includes plurality of parallel ribbed protrusions 22, and wherein the upper and lower portions of said surface engagingly fasten that portion of said tow 30a between the ribbed protrusions 22 and the ribbed troughs 20 to hold said fiber tow 30a in a fixed position, and further wherein the carbon fiber tow 30a is embedded in a sheath 38 comprised of a laminar silicon rubber material. A channel 16 connects a lead line 8 (FIG. 2) to contact 7. Buckle 24 formed around bend 13 secures the lower portion of the connector 10 fastening the tow 30a in place in connector 10.

As is now apparent from the foregoing, the connector 10 is completely mechanical in its construction and assembly and does not require ultrasound welding or any form of heat or adhesive bonding, thus adding to its reliability. The lack of any processes, except mechanical pressures, required to retain the carbon fiber 30 in the connector 10 eliminates manufacturing steps that limit the reliability of fiber connections at temperatures in excess of 400 F.

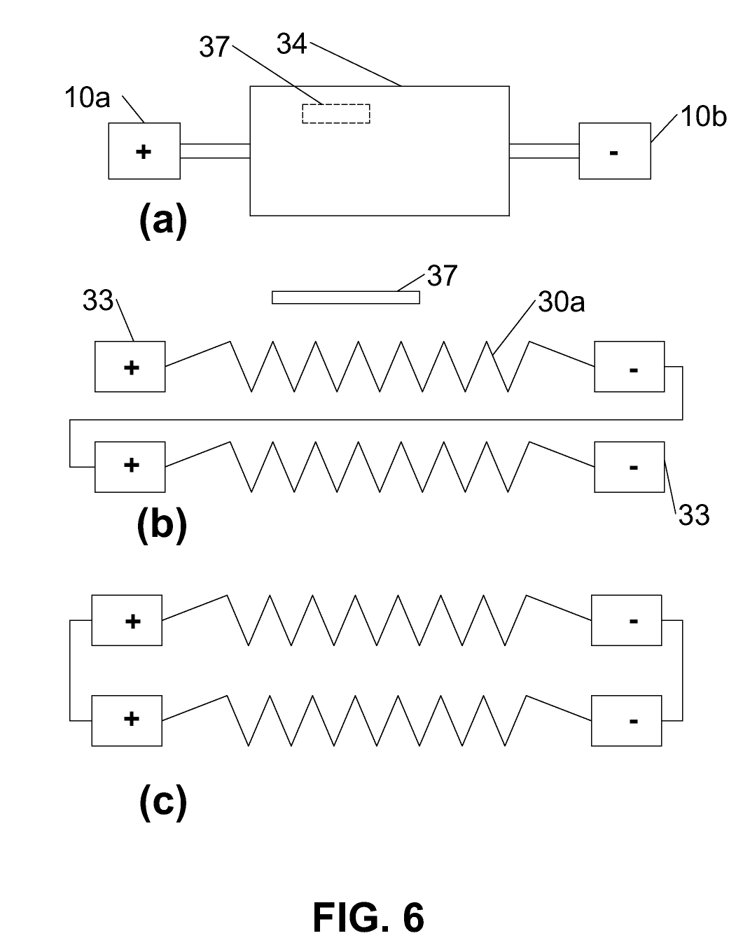

As shown in FIG. 6a, the heater 34 may be terminated by connector 10a, 10b (each connector as shown in FIG. 5a) to each terminus respectively of the fiber tow 30a. Connector 10a will connect the heater 34 to a voltage potential at connection contact 7. As shown in FIG. 6b, two or more heater 34 may be connected in series. In any case lead lines 8 (FIG. 2) must be provided at each terminal end of the heater to connect to the input power source at contact 7. As shown in FIG. 6c, two or more heater 34 may be connected in a parallel electrical connection. Additionally, the heat in proximity of the tow 30a may be regulated by a thermostat sensor 37 that by way of example may be connected to the connector 10a, 10b. The sensor 37 connects to the controller 87 to limit the power into the carbon fiber 30a tow heater 34. One purpose served by this sensor is to provide redundancy for fail safe operation in the event that a temperature sensor monitoring the temperature in the pan fails.

By way of example and not limitation 32 feet of 50K carbon fiber tow 30a yields approximately 165 degrees F. The temperature output decreases as the carbon fiber tow 30a length is increased or sections are added through a series connection. As in FIG. 6c, carbon fiber tow 30a sections can be added in parallel to maintain any temperature desired up to a maximum of the fiber carbon tow or the sheath temperature limitations.

An embodiment of the invention includes a method for controlling the temperature of the portable food apparatus 100 including incorporating the carbon fiber tow heater 34 to produce heat at the lower surface of the insulation pan 300; connecting the carbon fiber tow heater 34 to power source 85 utilizing a connector having an upper and a lower mating portion substantially opposing each other; and controlling the power source dependent on the temperature of the pan or of the food. One embodiment of the method for controlling the temperature of the portable food utensil 100 includes: embedding the plurality of carbon fiber tow 30a heating elements into the walls (42,43) of pan 300; inserting the pan 300 into the insulated cavity 230; connecting the carbon fiber tow to power source 85 utilizing the connector (10a, 10b) having an upper and a lower mating portion substantially opposing each other; and controlling the power source to carbon fiber tow dependent on setting the desired temperature of food in the pan.

In yet another embodiment a method of the invention includes, attaching carbon fiber tow 30a heater 35 onto the inner wall 42 of the pan 300; connecting power source 85 to the heater utilizing connector 10a, 10b, having upper and a lower mating portions substantially opposing each other; heating the wall 42 transferring heat to the surface and the space in contact with the food; receiving data from manually set input device 78 representing a desired temperature for the internal space or for the food in the pan; receiving data from first sensor 72 representing the temperature of one of the internal space or the food; receiving data from a second sensor 37 representing the temperature of the carbon fiber tow heater; controlling the supply of power 85 to the heater 34 dependent on the first sensor 72 data, the second sensor 37 data, and the input device 78 data representing a desired temperature to cook or keep food warm.

The invention herein also includes a method for controlling the temperature of portable food apparatus 100 by computing the required heat generation required from the carbon fiber tow heater 34 by taking into account heat loss through the walls of the pan and the insulation 203, 205 material of the apparatus 100, using one or more of (a) the cross-section of said insulation 203, 205, (b) material density of the insulation 203, 205, (c) specific coefficient of heat, (d) the volume between the heater 34 and the insulation 203, 205 surface and the thermal conductivity of the insulation 203, 205 to maximize the efficiency of the heat generated by the tow fiber heater 34.

The controller 87 comprises a processor (not shown), such as one or more conventional microprocessors and one or more supplementary co-processors such as math co-processors. The processor is in communication with a communication port through which the processor communicates with other devices such as sensors, 72, 74, 76 and temperature setting device 78. The communication port may include multiple communication channels for simultaneous communication with, for example, other processors. The processor may also be in communication with data storage devices (not shown). The data storage device may comprise an appropriate combination of magnetic, optical and/or semiconductor memory, and may include, for example, RAM, ROM, flash drive, an optical disc such as a compact disc and/or a hard disk or drive. The processor and the data storage device each may be, for example, located entirely within a single computer or other computing device; or connected to each other by a communication medium, such as a USB port, serial port cable, a coaxial cable, a Ethernet type cable, a telephone line, a radio frequency transceiver or other similar wireless or wireline medium or combination of the foregoing. The data storage device may store, for example, (i) a program (e.g., computer program code and/or a computer program product for executing software adapted to direct the processor in accordance with the present invention, and particularly in accordance with the processes described in detail hereinafter with regard to executing software; (ii) a database adapted to store information that may be utilized to store information required by the program for executing software. The program for executing software that may be stored, for example, in a compressed, an uncompiled and/or an encrypted format, and may include computer program code. The instructions of the program may be read into a main memory of the processor from a computer-readable medium other than the data storage device, such as from a ROM or from a RAM. While execution of sequences of instructions in the program causes the processor to perform the process steps described herein, hard-wired circuitry may be used in place of, or in combination with, software instructions for implementation of the processes of the present invention. Thus, embodiments of the present invention are not limited to any specific combination of hardware and software.

The term “computer-readable medium” as used herein refers to any medium that provides or participates in providing instructions to the processor of the computing device (or any other processor of a device described herein) for execution and more particularly for executing software. Such a medium may take many forms, including but not limited to, non-volatile media, volatile media, and transmission media. Non-volatile media include, for example, optical or magnetic disks, such as memory. Volatile media include dynamic random access memory (DRAM), which typically constitutes the main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM or EEPROM (electronically erasable programmable read-only memory), a FLASH-EEPROM, any other memory chip or cartridge, a carrier wave as described hereinafter, or any other medium from which a computer can read.

Various forms of computer readable media may be involved in carrying one or more sequences of one or more instructions to the processor (or any other processor of a device described herein) for executing software.

The present invention also includes computer software embodied on a computer readable medium for controlling the controller 87 including code for controlling the power source 85 dependent on the temperature in the well of the pan 300 or the food; receiving input data from temperature setting device 78 on the desired temperature of the pan 300 or the food; receiving data from sensors 72, 74, 76, 31 and 37, on the temperature conditions of the well of the pan and the food; controlling the power supply output heating of the pan 300 or food to keep the food suitably warm.

In yet another embodiment a computer software embodied on a computer readable medium for controlling the temperature of the portable food utensil 100 includes code for: receiving one or more sensor data from sensors 72,74,76, 31 and 37 on the temperature condition of the pan, such as the surface of the outer wall 42 of the heating pan 300 or the food; controlling a power source 85 supplying power to carbon fiber tow 30a heater 34 dependent on the sensor data; receiving sensor data from temperature setting device 78 on the desired temperature inside the pan 300; controlling the power source 85 supplying power to the carbon fiber tow heater 34 dependent on sensor data to maintain a desirable temperature of the food situated in the utensil 100.

While the present invention has been described with reference to the illustrative embodiments, this description is not intended to be construed in a limiting sense. Various modifications of the illustrative embodiments, as well as other embodiments of the invention, will be apparent to those skilled in the art on reference to this description. It is therefore contemplated that the appended claims will cover any such modifications or embodiments as fall within the true scope of the invention.

What is claimed is:

1. A portable food apparatus comprising a cavity having a chafing pan installed into an insulation material, and wherein one or more carbon fiber tow heating elements are affixed to one or more of external surfaces of said pan, said heating elements electrically connecting to a controllable power source utilizing a connector having an upper and lower portion that engagingly fastens a portion of said tow between ribbed protrusions and ribbed troughs to hold said fiber in position, such that the power source enables the heating of food.

2. The portable food apparatus of claim 1, wherein the heating element is in direct contact with the external surface of the pan.

3. The portable food apparatus of claim 1 further comprising a controller such that the heating element maintains a temperature for the heating of food.

4. The portable food apparatus of claim 3, including a sensor to measure the temperature of one of (a) the internal pan space, (b) the food, or the walls embedding a plurality of carbon fiber tow heating elements.

5. The portable food apparatus of claim 4, wherein the controller utilizes data representing a setting of the temperature desired in one of (a) the pan or (b) the food.

6. The portable food apparatus of claim 4, including a sensor to measure the temperature of the carbon fiber tow.

7. A portable food apparatus comprising a cavity having a metallic pan installed therein, said pan having five enclosing surfaces including a lower surface, wherein one or more carbon fiber tow heating elements are directly affixed to said bottom of the lower surface, said pan including the heating elements embedded into a none rigid insulation material, said heating elements electrically connecting to a controllable direct current power source utilizing a metallic connector having an upper and lower portion that engagingly fastens a portion of said tow between ribbed protrusions and ribbed troughs to hold said fiber in position, such that the power source enables the heating of food.

8. A method for controlling the temperature of the portable food utensil includes attaching a carbon fiber tow heater onto the inner wall of the pan; embedding the pan and the carbon fiber tow heater into an insulation member, connecting a power source to the heater utilizing a connector having an upper and a lower mating portion substantially opposing each other; heating the wall transferring heat to the surface and the space in contact with the food; receiving data from a manually set input device representing a desired temperature for the internal space or for the food in the pan; receiving data from a first sensor representing the temperature of one of the internal space or the food; receiving data from a second sensor representing the temperature of the carbon fiber tow heater; controlling the supply of power to the heater dependent on the first sensor data, the second sensor data, and the data representing a desired temperature to cook or keep food warm.

9. The method of claim 8 wherein attaching a carbon fiber tow heater onto the inner wall of the pan includes embedding into the walls of a pan.

10. The method of claim 8 further including inserting the pan into an insulated cavity.

11. The method of claim 8 including measuring the temperature of the food.

12. Computer software for controlling the temperature of portable food apparatus including a cavity having a pan installed therein, said pan having a enclosing surfaces, wherein one or more carbon fiber tow heating elements are affixed to one or more of said surfaces, said pan including the heating elements embedded into an insulation material, said heating elements electrically attaching to a controllable power source utilizing a connector having an upper and lower portion that engagingly fastens a portion of said tow between ribbed protrusions and ribbed troughs to hold said fiber in position, such that the power source enables the heating of food, said software embodied on a computer readable medium comprising code for: receiving data from a manually set input device representing a desired temperature for one of the internal space or for the food in the pan; receiving data from a first sensor representing the temperature of one of the internal space or the food; receiving data from a second sensor representing the temperature of the carbon fiber tow heater; controlling the supply of power to the heater dependent on the first sensor data, the second sensor data, and the data representing a desired temperature to cook or keep food warm.
